(19) United States
(12) Patent Application Publication
(10) Pub. No.: US 2009/0160353 A1
(43) Pub. Date: Jun. 25, 2009

(54) MULTI-LAMP BACKLIGHT APPARATUS

(75) Inventors: Ming Yan YANG, Taoyuan City (TW); Chin Long YANG, Bade City (TW); Chao Jung LIN, Bade City (TW); Ming Yen WU, Taoyuan City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: DARFON ELECTRONICS CORP., Taoyuan (TW)

(21) Appl. No.: 12/208,476

(22) Filed: Sep. 11, 2008

(30) Foreign Application Priority Data
Dec. 21, 2007 (TW) 096221781

(51) Int. Cl. H05B 41/16

(52) U.S. Cl. 315/278

(57) ABSTRACT

The invention discloses a multi-lamp backlight apparatus. The multi-lamp backlight apparatus includes a first lamp, a second lamp, a controlling unit, a resonating unit, and a balance transformer. The controlling unit is used for generating a controlling signal. The resonating unit is used for converting the controlling signal into a resonating signal. The balance transformer includes a primary winding, a first secondary winding, and a second secondary winding. The primary winding is used for receiving the resonating signal. The first secondary winding is corresponding to the primary winding and coupled to the first lamp. The second secondary winding is corresponding to the primary winding and coupled to the second lamp.

### CROSS-REFERENCE TO RELATED APPLICATIONS

This non-provisional application claims priority under 35 U.S.C. §119(a) on Patent Application No. 096221781 filed in Taiwan, R.O.C. on Dec. 21, 2007, the entire contents of which are hereby incorporated by reference.

### BACKGROUND OF THE INVENTION

1. Field of the Invention

The invention relates to a multi-lamp backlight apparatus and, more particularly, to a multi-lamp backlight apparatus with fewer balance transformers to achieve series-wound resonating effect at the primary side.

2. Description of the Prior Art

Accompanied with a continuously enlarged size of Liquid Crystal Display (LCD) panel in recent years, a backlight apparatus with multiple Cold Cathode Fluorescent Lamps (CCFLs) have been broadly applied to be used as a high quality light source for LCD panel.

In order to approximately maintain an equal current for each lamp, there is a balance circuit structure comprising a balance transformer in prior art, so as to provide a LCD light source with stable and even brightness.

FIG. 1 is a schematic diagram illustrating a multi-lamp backlight apparatus with a series-wound resonating balance circuit structure at the primary side. As shown in FIG. 1, based on the balance circuit structure, a controlling signal (i.e. square wave), which is generated by an alternating current (AC) power source 16 of a multi-lamp backlight apparatus 1, can be converted into a resonating signal (i.e. sine wave) by a resonating circuit 14. Afterward, the resonating signal is transmitted to a primary winding 102 of a balance transformer 10. Then, the resonating signal is transmitted from a secondary winding 104 of the balance transformer 10 to a lamp 12, which is corresponding to the balance transformer 10, through a connector 18, so as to drive the lamp 12.

As shown in FIG. 1, it is assumed that the multi-lamp backlight apparatus 1 comprises ten lamps 12. Since one balance transformer 10 can only be coupled to one lamp 12 in the balance circuit structure of the prior art, the multi-lamp backlight apparatus 1 needs ten balance transformers 10 to achieve series-wound resonating effect at the primary side.

In this series-wound resonating balance circuit structure at the primary side, the multi-lamp backlight apparatus needs equal number of balance transformers and corresponding lamps. However, when the multi-lamp backlight comprises a large number of lamps, to have the corresponding number of transformers is impractical considering the cost and space taken in practical products.

Therefore, the invention provides a multi-lamp backlight apparatus to solve the aforesaid problems.

### SUMMARY OF THE INVENTION

A scope of the invention is to provide a multi-lamp backlight apparatus. According to an embodiment, the multi-lamp backlight apparatus comprises a first lamp, a second lamp, a controlling unit, a resonating unit, and a balance transformer.

The controlling unit is used for generating a controlling signal. The resonating unit is electrically connected to the controlling unit and used for converting the controlling signal into a resonating signal. The balance transformer comprises a primary winding, a first secondary winding, and a second secondary winding. The primary winding is electrically connected to the resonating unit and used for receiving the resonating signal. The first secondary winding is corresponding to the primary winding and coupled to the first lamp. At the same time, the second secondary winding is corresponding to the primary winding and coupled to the second lamp.

Compared to the prior art, a multi-lamp backlight apparatus of the invention can improve the weakness that one balance transformer can control only one lamp (singular to singular) in the series-wound resonating balance circuit structure at the primary side of the prior art. The multi-lamp backlight apparatus of the invention comprises a balance circuit structure with a balance transformer, which can control two lamps (singular to double) or four lamps (singular to quad). Not only the series-wound resonating effect at the primary side can be achieved, but also the multi-lamp backlight apparatus of the invention is capable of simplifying the structure of series-wound resonating circuit at the primary side, so as to reduce the product cost.

The advantage and spirit of the invention may be understood by the following recitations together with the appended drawings.

### BRIEF DESCRIPTION OF THE APPENDED DRAWINGS

FIG. 1 is a schematic diagram illustrating a multi-lamp backlight apparatus with a series-wound resonating balance circuit structure at the primary side.

FIG. 2 is a schematic diagram illustrating a first embodiment of multi-lamp backlight apparatus according to the invention.

FIG. 3 is a schematic diagram illustrating a second embodiment of multi-lamp backlight apparatus according to the invention.

FIG. 4 is a schematic diagram illustrating basic structure of a first balance transformer shown in FIG. 2.

FIG. 5 is a schematic diagram illustrating basic structure of a first balance transformer shown in FIG. 3.

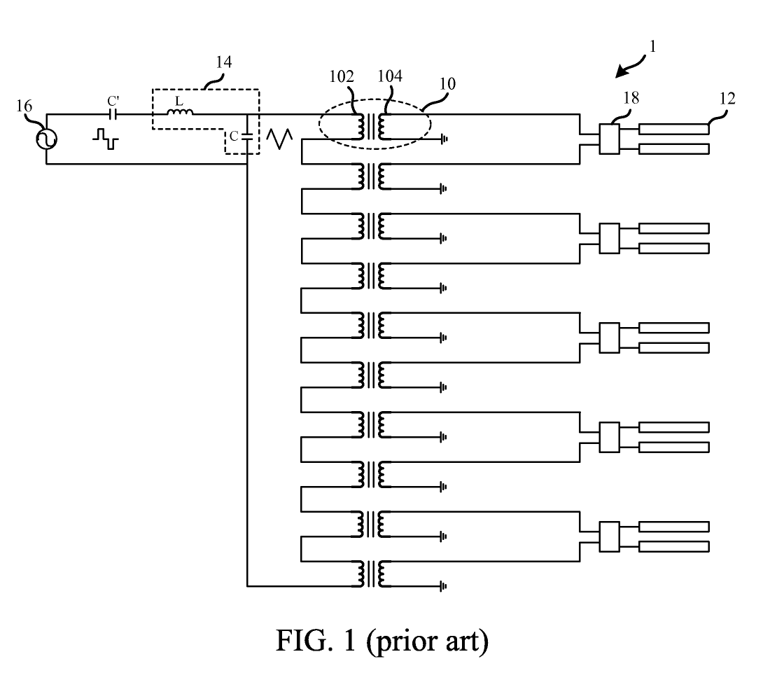

### DETAILED DESCRIPTION OF THE INVENTION

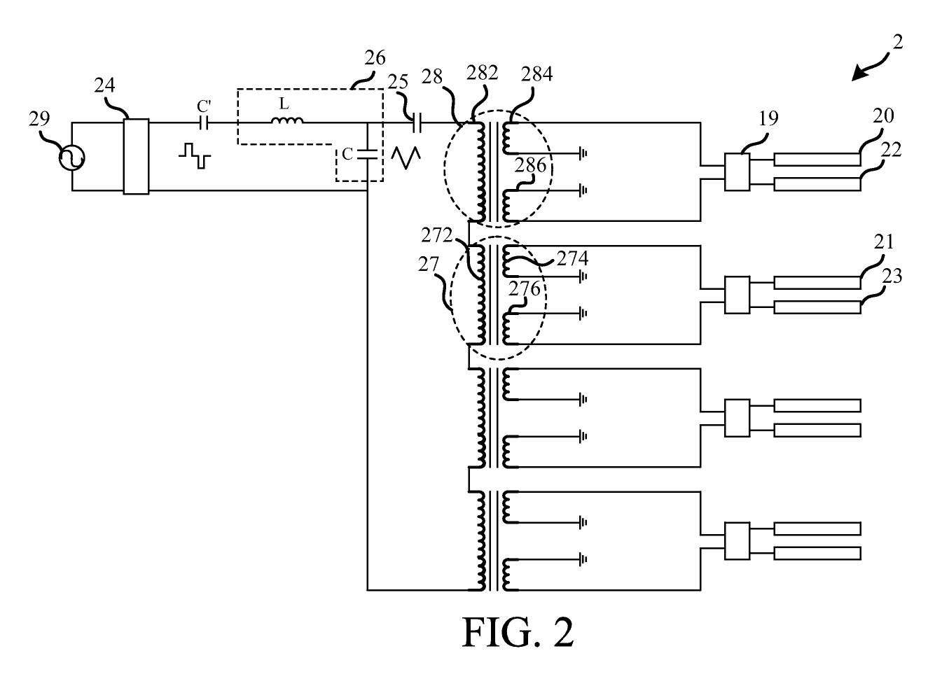

A first embodiment according to the invention comprises a multi-lamp backlight apparatus. Please refer to FIG. 2. FIG. 2 is a schematic diagram illustrating a first embodiment of multi-lamp backlight apparatus according to the invention.

Please refer to FIG. 2. The multi-lamp backlight apparatus 2 comprises a first lamp 20, a second lamp 22, a connector 19, a controlling unit 24, a filtering capacitor 25, a resonating unit 26, a first balance transformer 28, and an alternating current (AC) power source 29.

The following is the detailed introduction, which is about the function and operation in practice of each unit included in the multi-lamp backlight apparatus 2.

The controlling unit 24 is electrically connected to the AC power source 20 and used for generating a controlling signal with the AC power 29. In practical application, the controlling unit 24 may comprise a full-bridge circuit or a half-bridge circuit.

The resonating unit 26 is electrically connected to the controlling unit 24 and used for converting the controlling signal, generated by the controlling unit 24, into a resonating signal. In other words, the converting via the resonating unit 26 is capable of transforming square wave, input by controlling unit 24, into resonating sine wave. In practical application, resonating unit 26 may comprise a capacitor and an inductor. Therefore, the resonating unit 26 may consist of an LC resonating circuit. In practical application, the filtering capacitor 25 may be located between resonating unit 26 and the first balance transformer 28. The filtering capacitor 25 is capable of completing a filtering process to the sine wave, which is generated by the resonating unit 26.

The first balance transformer 28 comprises a first primary winding 282, a first secondary winding 284, and a second secondary winding 286. The first primary winding 282 is electrically connected to the resonating unit 26 and used for receiving the resonating signal. The first secondary winding 284 is corresponding to the first primary winding 282 and coupled to the first lamp 20. The second secondary winding 286 is corresponding to the first primary winding 282 and coupled to second lamp 22. In practical application, the first secondary winding 284 and the second secondary winding 286 are connected respectively to the first lamp 19 and the second lamp 22 through the connector 19.

In the multi-lamp backlight apparatus 2, the first balance transformer 28 is corresponding to the first lamp 20 and the second lamp 22. Therefore, the first balance transformer 28 is a singular-to-double balance transformer.

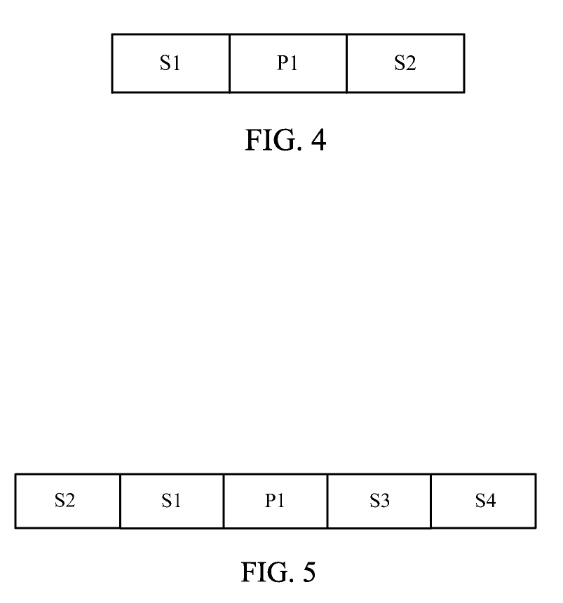

Please refer to FIG. 4. FIG. 4 is a schematic diagram illustrating basic structure of a first balance transformer shown in FIG. 2. The mark P1 at the center represents the first primary winding 282. The marks S1 and S2 aside represent first secondary winding and the second secondary winding respectively.

The resonating unit 26 converts the controlling signal, generated by the controlling unit 24, into the resonating signal. Afterward, the first primary winding 282 of the first balance transformer 28 receives the resonating signal from the resonating unit 26.

By the first balance transformer 28, the resonating signal can be converted into transformed resonating signals, which comprise a first transformed resonating signal corresponding to the first secondary winding 284 and a second transformed resonating signal corresponding to the second secondary winding 286, because the balance transformer 28 comprises both the first secondary winding 284 and the second secondary winding which are corresponding to the first primary winding 282. The first transformed resonating signal and the second transformed resonating signal are still sine waves respectively.

Afterward, the first secondary winding 284 can transmit the first transformed resonating signal to the first lamp 20. The first transformed resonating signal can be used to drive the first lamp 20. The second secondary winding 286 can transmit the second transformed signal to the second lamp 22, for driving the second lamp 22.

Besides, the multi-lamp backlight apparatus 2 may further comprise more balance transformers and multiple lamps which are corresponding to the transformers respectively. Such as the multi-lamp backlight apparatus 2 further comprises a third lamp 21, a fourth lamp 23, and a second balance transformer 27 in FIG. 2.

The second balance transformer 27 comprises a second primary winding 272, a third secondary winding 274, and a fourth secondary winding 276. The third secondary winding 274 and fourth secondary winding 276 are corresponding to the second primary winding 272.

In order to achieve series-wound resonating effect at the primary side in the multi-lamp backlight apparatus 2, all the primary windings are connected in series. As showed in FIG. 2, the first primary winding 282 and the second primary winding 272 are connected in series. In the mean time, the third secondary winding 274 is coupled to the third lamp 21, and the fourth secondary winding 276 is coupled to the fourth lamp 23. In addition, FIG. 2 also shows another two balance transformers and the corresponding lamps, which repeat the aforesaid example.

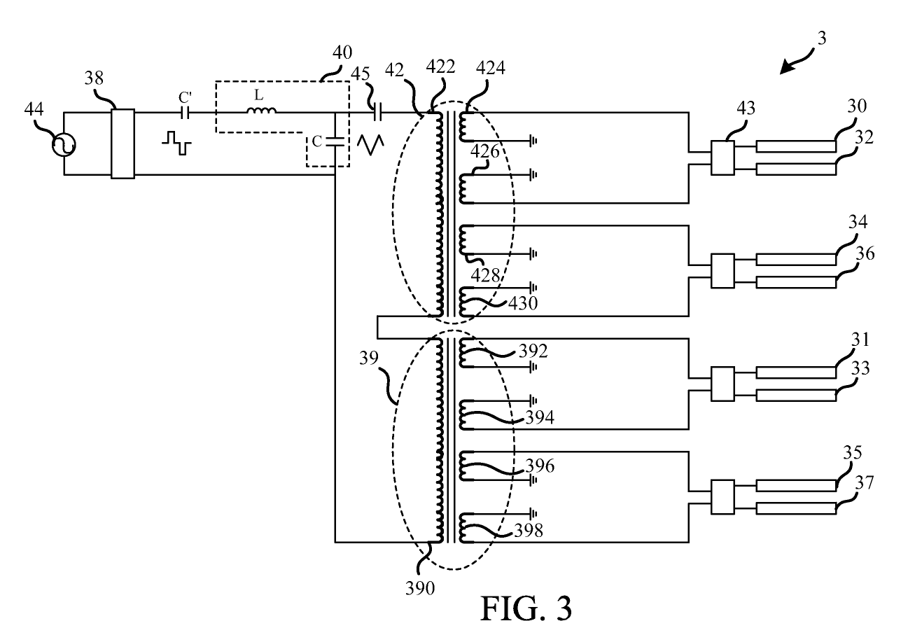

A second embodiment according to the invention is a multi-lamp backlight apparatus shown in FIG. 3. FIG. 3 is a schematic diagram illustrating a second embodiment of multi-lamp backlight apparatus according to the invention.

Please refer to FIG. 3, a multi-lamp backlight apparatus 3 comprises a first lamp 30, a second lamp 32, a third lamp 34, a fourth lamp 36, a connector 43, a controlling unit 38, a filtering capacitor 45, a resonating unit 40, a first balance transformer 42, and an alternating power (AC) power source 44.

The following is a detailed introduction to the function and operation in practice of each unit included in the multi-lamp backlight apparatus 3.

The controlling unit 38 is electrically connected to the AC power source 44 and used for generating a controlling signal with the AC power 44. In practical application, the controlling unit 38 may comprise a full-bridge circuit or a half-bridge circuit.

The resonating unit 40 is electrically connected to the controlling unit 38 and used for converting the controlling signal into a resonating signal. In other words, the resonating unit 40 is capable of transforming square wave, input by controlling unit 38, into resonating sine wave. In practical application, resonating unit 40 may comprise a capacitor and an inductor. Therefore, the resonating unit 40 may include an LC resonating circuit. In practical application, the filtering capacitor 45 may be located between resonating unit 40 and the first balance transformer 42. The filtering capacitor 45 is capable of completing a filtering process to the sine wave, which is generated by the resonating unit 40.

The balance transformer 42 comprises a first primary winding 422, a first secondary winding 424, a second secondary winding 426, a third secondary winding 428, and a fourth secondary winding 430. The first primary winding 422 is electrically connected to the resonating unit 40 and used for receiving the resonating signal generated by the resonating unit 40.

The first secondary winding 424 is corresponding to the first primary winding 422 and coupled to the first lamp 30. The second secondary winding 426 is corresponding to the first primary winding 422 and coupled to the second lamp 32. The third secondary winding 428 is corresponding to the first primary winding 422 and coupled to the third lamp 34. The fourth secondary winding 430 is corresponding to the first primary winding 422 and coupled to the fourth lamp 36. In practical application, the first secondary winding 424, the second secondary winding 426, the third secondary winding 428, and the fourth secondary winding 430 are respectively connected to the first lamp 30, the second lamp 32, the third lamp 34, and the fourth lamp 36 via the connector 43.

In the multi-lamp backlight apparatus 3, the first balance transformer 42 is corresponding to the first lamp 30, the second lamp 32, the third lamp 34, and the fourth lamp 36 at once. To sum up, the first balance transformer 42 is a singular-to-quad balance transformer.

Please refer to FIG. 5. FIG. 5 is a schematic diagram illustrating basic structure of a first balance transformer shown in FIG. 3. In FIG. 5, the mark P1 at the center represents the first primary winding 422. The marks S1, S2, S3, and S4 are respectively representing the first secondary winding 424, the second secondary winding 426, the third secondary winding 428, and the fourth secondary winding 430. At first, that the resonating unit 40 converts the controlling signal, generated by the controlling unit 38, into the resonating signal, then, the first primary winding 422 of the first balance transformer 42 receives the signal from resonating unit 40.

The secondary side of the first balance transformer 42 comprises the first secondary winding 424, the second secondary winding 426, the third secondary winding 428, and the fourth secondary winding 430. Therefore, through the first balance transformer 42, the resonating signal can be converted into a first transformed resonating signal corresponding to the first secondary winding 424, a second transformed resonating signal corresponding to the second secondary winding 426, a third transformed resonating signal corresponding to the third secondary winding 428, and a fourth transformed resonating signal corresponding to the fourth secondary winding 430. The first transformed resonating signal, the second transformed resonating signal, the third transformed resonating signal, and the fourth transformed resonating signal are respectively sine waves still.

Afterward, the first secondary winding 424 can transmit the first transformed resonating signal to the first lamp 30. The first transformed resonating signal can be used to drive the first lamp 30. The second secondary winding 426 can transmit the second transformed signal to the second lamp 32, for driving the second lamp 32. The third secondary winding 428 can transmit the third transformed signal to the third lamp 34, for driving the third lamp 34. The fourth secondary winding 430 can transmit the fourth transformed signal to the second lamp 36, for driving the fourth lamp 36.

Besides, the multi-lamp backlight apparatus 3 may further comprise a fifth lamp 31, a sixth lamp 33, a seventh lamp 35, a eighth lamp 37, and a second balance transformer 39, as shown in FIG. 3. The second balance transformer 39 comprises a second primary winding 390, a fifth secondary winding 392, a sixth secondary winding 394, a seven secondary winding 396, and a eighth secondary winding 398.

In order to achieve series-wound primary side resonating, all the primary windings in the multi-lamp backlight apparatus 3 are connected in series. As showed in FIG. 3, that the first primary winding 422 and the second primary winding 390 are connected in series. In the mean time, the fifth secondary winding 392 is coupled to the fifth lamp 31. The sixth secondary winding 394 is coupled to the sixth lamp 33. The seventh secondary winding 396 is coupled to the seventh lamp 35. The eighth secondary winding 398 is coupled to the eighth lamp 37.

In addition, FIG. 3 also shows another two balance transformers and the corresponding lamps in the multi-lamp backlight apparatus 3, which repeat the example aforesaid.

Compared to the prior art, a multi-lamp backlight apparatus of the invention can improve the weakness that one balance transformer can only control one lamp (singular to singular) in the series-wound resonating balance circuit structure at the primary side of the prior art. The multi-lamp backlight apparatus of the invention comprises a balance circuit structure with a balance transformer, which can control two lamps (singular to double) or four lamps (singular to quad). Not only the series-wound resonating effect at the primary side can be achieved, but the multi-lamp backlight apparatus of the invention is capable of simplifying the structure of series-wound resonating circuit at the primary side, so as to reduce the product cost.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A multi-lamp backlight apparatus comprising:
a first lamp;
a second lamp;
a controlling unit for generating a controlling signal;
a resonating unit, electrically connected to the controlling unit, for converting the controlling signal into a resonating signal; and
a first balance transformer comprising:
a first primary winding, electrically connected to the resonating unit, for receiving the resonating signal;
a first secondary winding corresponding to the first primary winding and coupled to the first lamp; and
a second secondary winding corresponding to the first primary winding and coupled to the second lamp.

2. The multi-lamp backlight apparatus of claim 1, wherein the controlling unit comprises a full-bridge circuit or a half-bridge circuit.

3. The multi-lamp backlight apparatus of claim 1, wherein the resonating unit comprises a capacitor and an inductor.

4. The multi-lamp backlight apparatus of claim 1, wherein the controlling signal is a square wave.

5. The multi-lamp backlight apparatus of claim 1, wherein the resonating signal is a sine wave.

6. The multi-lamp backlight apparatus of claim 1, further comprising:
an alternating current (AC) power source electrically connected to the controlling unit, the controlling unit generating the controlling signal with the AC power source.

7. The multi-lamp backlight apparatus of claim 1, further comprising a second balance transformer, a third lamp, and a fourth lamp, the second balance transformer comprising a third secondary winding, a fourth secondary winding, and a second primary winding, wherein the first primary winding and the second primary winding are connected in series, the third secondary winding is coupled to the third lamp, and the fourth winding is coupled to the fourth lamp.

8. A multi-lamp backlight apparatus comprising:
a first lamp;
a second lamp;
a third lamp;
a fourth lamp;
a controlling unit for generating a controlling signal;
a resonating unit, electrically connected to the controlling unit, for converting the controlling signal into a resonating signal; and
a first balance transformer comprising:
a first primary winding, electrically connected to the resonating unit, for receiving the resonating signal;
a first secondary winding corresponding to the first primary winding and coupled to the first lamp;
a second secondary winding corresponding to the first primary winding and coupled to the second lamp;
a third secondary winding corresponding to the first primary winding and coupled to the third lamp; and
a fourth secondary winding corresponding to the first primary winding and coupled to the fourth lamp.

9. The multi-lamp backlight apparatus of claim 8, wherein the controlling unit comprises a full-bridge circuit or a half-bridge circuit.

10. The multi-lamp backlight apparatus of claim 8, wherein the resonating unit comprises a capacitor and an inductor.

11. The multi-lamp backlight apparatus of claim 8, wherein the controlling signal is a square wave.

12. The multi-lamp backlight apparatus of claim 8, wherein the resonating signal is a sine wave.

13. The multi-lamp backlight apparatus of claim 8, further comprising:
an alternating current (AC) power source, electrically connected to the controlling unit, the controlling unit generating the controlling signal with the AC power source.

14. The multi-lamp backlight apparatus of claim 8, further comprising a second balance transformer, a fifth lamp, a sixth lamp, a seventh lamp, and an eighth lamp, the second balance transformer comprising a fifth secondary winding, a sixth secondary winding, a seventh secondary winding, an eighth secondary winding, and a second primary winding, wherein the first primary winding and the second primary winding are connected in series, the fifth, sixth, seventh, and eighth secondary windings are coupled to the fifth, sixth, seventh, and eighth lamps, respectively.
